(19) United States
(12) Patent Application Publication
(10) Pub. No.: US 2006/0103713 A1
(43) Pub. Date: May 18, 2006

(54) Thermal transfer image forming apparatus and method using low voltage differential signaling method

(75) Inventor: In-su Hwang, Daejcon Metropolitan-City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/214,898

(22) Filed: Aug. 31, 2005

(30) Foreign Application Priority Data
Nov. 16, 2004 (KR) 10-2004-0093537

(51) Int. Cl. B41J 2/32; B41J 2/315; G01D 15/10

(52) U.S. Cl. 347/171

(57) ABSTRACT

An image forming apparatus and method using a thermal printhead that prints an image by heating a medium are provided. The image forming apparatus includes a data input unit which receives image data to be printed, a control unit which generates a control signal used for driving the thermal printhead based on the received image data, and a thermal printhead which prints an image by heating the medium in response to the control signal. The control unit includes a main controller which comprises a low voltage differential signaling (LVDS) driver that converts a signal input thereto into a low voltage differential signal and outputs the low voltage differential signal, and a sub-controller which comprises an LVDS receiver that receives the low voltage differential signal from the LVDS driver of the main controller. Accordingly, it is possible to reduce the number of data lines required between the main controller and the sub-controller by transmitting data between the main controller and the sub-controller as low voltage differential signals, and enhance the performance of the image forming apparatus while reducing the manufacturing costs and reducing electromagnetic interference.

### CROSS-REFERENCE TO RELATED APPLICATIONS

This application claims the benefit under 35 U.S.C. 119(a) of Korean Patent Application No. 10-2004-0093537, filed in the Korean Intellectual Property Office on Nov. 16, 2004, the entire disclosure of which is incorporated herein by reference.

### FIELD OF THE INVENTION

The present invention relates to an image forming apparatus and method using a thermal printhead that prints an image by heating a medium. More particularly, the present invention relates to an image forming apparatus and method which transmit data between a main controller and a sub-controller using low voltage differential signals.

### DESCRIPTION OF THE RELATED ART

Image forming apparatuses convert a document written by a user using an application program or a picture taken by the user with a digital camera into data, and then output the data in such a manner that the data can be seen by a user.

Recently, thermal transfer printing devices that can provide high printing quality have been developed. Thermal transfer printing devices are devices that form an image by heating an ink ribbon with a thermal printhead so that a medium in direct contact with the ink ribbon can be heated along with the ink ribbon and thus, ink can be transferred to the medium. Such devices can further form an image by heating a medium on which an ink layer is formed that realizes a predetermined color when reacting with heat from a thermal printhead.

A thermal printhead includes a plurality of heating elements, each having a resistance value R. Each of the heating elements generates heat when a predetermined voltage VHC is applied thereto, and applies the generated heat to a medium so that an image can be printed on the medium. The more heating elements the thermal printhead includes, the higher the printing quality the thermal printhead can provide. However, the more heating elements that the thermal printhead includes, the more control signals are required for controlling the operation of the thermal printhead.

In addition, as the number of clock signals, strobe signals, latch signals, and other data signals required for controlling the operation of the thermal printhead increase, the number of data lines required also increases. Thus, the amount of noise and power consumption of the thermal printhead increases. In addition, it is difficult to realize a printed circuit board (PCB) for use with the thermal printhead, and electromagnetic interferences (EMI) are more likely to occur.

Accordingly, a need exists for a system and method for reducing noise and power consumption of a thermal printhead operation while achieving higher printing quality.

### SUMMARY OF THE INVENTION

The present invention substantially solves the above and other problems, and provides an image forming apparatus and method using a thermal printhead that transmit data between a main controller and a sub-controller, which generate control signals for controlling the operation of the thermal printhead, using serial low voltage differential signals.

According to an aspect of the present invention, an image forming apparatus is provided using a thermal printhead that prints an image by heating a medium. The image forming apparatus comprises a data input unit which receives image data to be printed, a control unit which generates a control signal used for driving the thermal printhead based on the received image data, and a thermal printhead which prints an image by heating the medium in response to the control signal. The control unit comprises a main controller which comprises a low voltage differential signaling (LVDS) driver that converts a signal input thereto into a low voltage differential signal and outputs the low voltage differential signal, and a sub-controller which comprises an LVDS receiver that receives the low voltage differential signal from the LVDS driver of the main controller.

The sub-controller may be comprised of a thermal printhead controller which receives a signal from the main controller, generates signals used for driving the thermal printhead based on the received signal, and outputs the generated signals.

The sub-controller may also comprise a converter which converts the low voltage differential signal received by the LVDS receiver into a transistor-transistor logic level (TTL) signal.

The sub-controller may also comprise a converter which converts the low voltage differential signal received by the LVDS receiver into a complementary metal oxide semiconductor (CMOS) level signal.

The sub-controller may also comprise an LVDS driver which receives a signal from the main controller, converts the received signal into a low voltage differential signal, and outputs the low voltage differential signal.

The main controller may also comprise an LVDS receiver which receives a low voltage differential signal output from the sub-controller.

The LVDS driver may comprise two or more current sources and two or more data input ports.

The LVDS receiver may comprise three or more comparators and an OR gate.

According to another aspect of the present invention, an image forming method is provided for using a thermal printhead that prints an image by heating a medium. The image forming method comprises the steps of receiving image data to be printed, generating a first signal based on the received image data, converting the first signal into a low voltage differential signal and outputting the low voltage differential signal, receiving the low voltage differential signal and converting the low voltage differential signal into a second signal, generating control signals used for controlling the operation of the thermal printhead based on the second signal, and printing an image by heating a medium with the thermal printhead in response to the control signals.

The second signal may be comprised of a TTL level signal.

The second signal may be comprised of a CMOS level signal.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of an image forming apparatus according to an exemplary embodiment of the present invention;

FIG. 2 is a circuit diagram illustrating a low voltage differential signaling (LVDS) driver and an LVDS receiver that receive and/or transmit a low voltage differential signal to and/or from each other according to an embodiment of the present invention;

FIG. 3 is a circuit diagram illustrating another LVDS driver and another LVDS receiver that receive and/or transmit a low voltage differential signal to and/or from each other according to an embodiment of the present invention;

FIGS. 4A through 4D are circuit diagrams illustrating exemplary operations of the LVDS driver and LVDS receiver of FIG. 3 according to an embodiment of the present invention; and

FIG. 5 is a flowchart of an image forming method according to an exemplary embodiment of the present invention.

Throughout the drawings, like reference numerals will be understood to refer to like parts, components and structures.

### DETAILED DESCRIPTION OF THE EXEMPLARY EMBODIMENTS

The present invention will now be described more fully with reference to the accompanying drawings in which exemplary embodiments of the invention are shown.

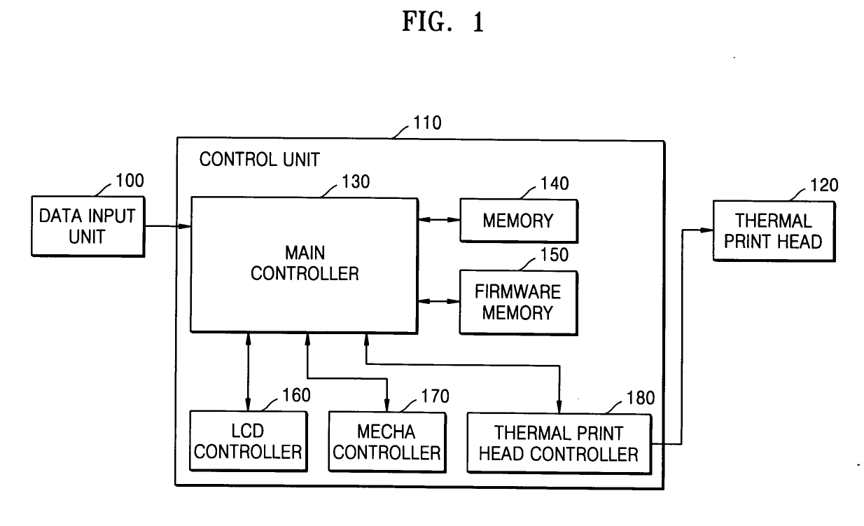

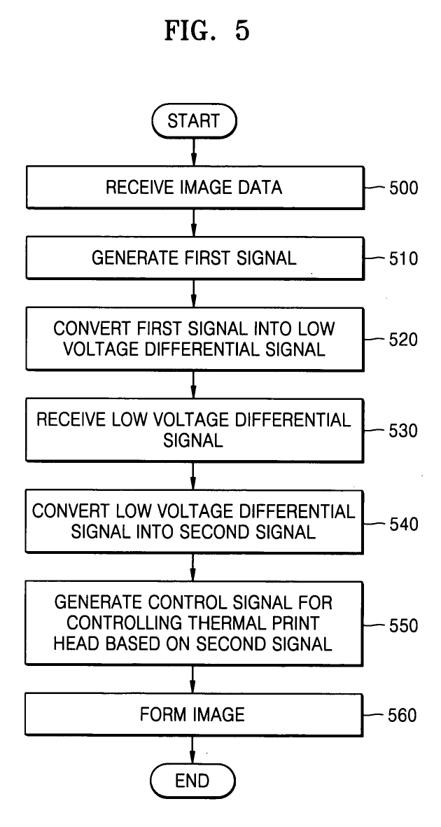

FIG. 1 is a block diagram of an image forming apparatus according to an exemplary embodiment of the present invention. Referring to FIG. 1, the image forming apparatus comprises a data input unit 100, a control unit 110, and a thermal printhead 120. In an exemplary embodiment of the present invention, the control unit 110 comprises a main controller 130, a memory 140, a firmware memory 150, a liquid crystal display (LCD) controller 160, a Mecha controller 170, and a thermal printhead controller 180. The operation of the image forming apparatus will now be described in detail with reference to FIG. 5.

FIG. 5 is a flowchart of an image forming method according to an exemplary embodiment of the present invention. Referring to FIGS. 1 and 5, in operation 500, the data input unit 100 receives image data to be printed from a personal computer, digital camera, personal digital assistant (PDA), or similar device.

The control unit 110 generates signals required for controlling the operation of the thermal printhead 120 based on the received image data. Preferably, but not necessarily, the control unit 110 comprises the main controller 130, memory 140, firmware memory 150, liquid crystal display (LCD) controller 160, Mecha controller 170, and the thermal printhead controller 180.

The main controller 130 receives the image data from the data input unit 100 and controls the operation of the image forming apparatus of FIG. 1 using a firmware program stored in the firmware memory 150. The firmware program is comprised of a program installed in a computer device so that it becomes a permanent part of the computer device. The firmware program may be installed in a flash memory.

The main controller 130 converts the image data, which is input to the image forming apparatus as red (R), green (G), and blue (B) signals, into cyan (C), magenta (M), and yellow (Y) data, decompresses the image data, generates control signals and temporarily stores the generated control signals in the memory 140, and outputs the stored control signals to the thermal printhead controller 180, which is comprised of a sub-controller.

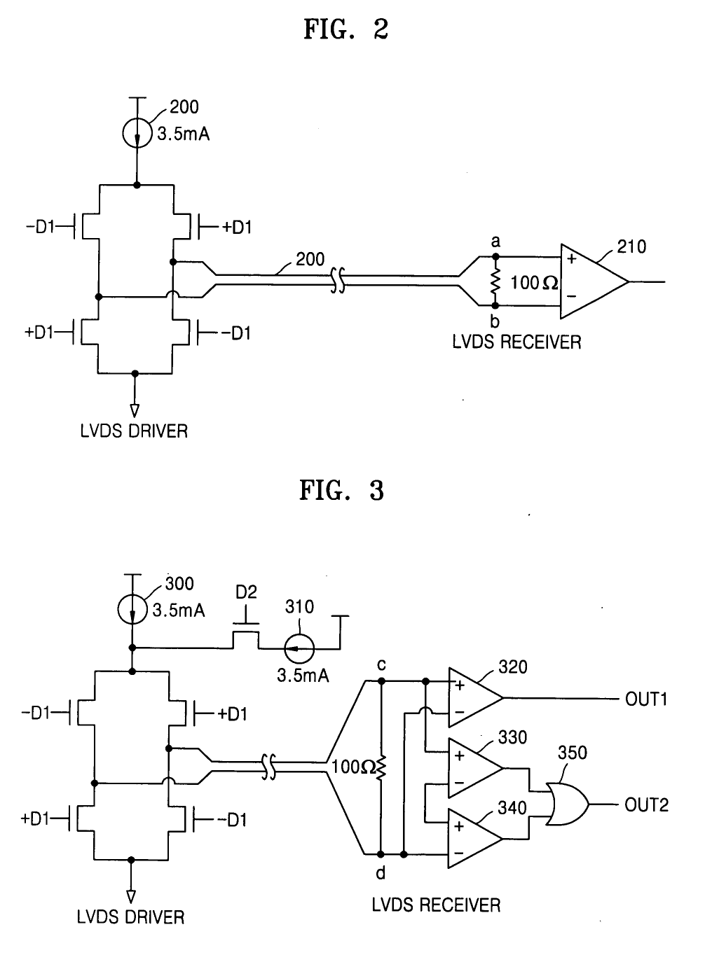

In operation 510, the main controller 130 generates a first signal used for controlling the operation of the thermal printhead controller 180. The main controller 130 further comprises a low voltage differential signalling (LVDS) driver (described in greater detail below with reference to FIGS. 2 and 3). In operation 520, the LVDS driver included in the main controller 130, converts the first control signal into a low voltage differential signal and the outputs the low voltage differential signal. The operation of the LVDS driver will be described in greater detail below with reference to FIG. 2. Preferably, but not necessarily, the main controller 130 also includes an LVDS receiver (described in greater detail below with reference to FIGS. 2 and 3), which receives a low voltage differential signal from any of the thermal printhead controller 180, LCD controller 160, and Mecha controller 170 (that is, sub-controllers 160, 170, and 180).

The thermal printhead controller 180 further comprises an LVDS receiver (described in greater detail below with reference to FIGS. 2 and 3), which receives the low voltage differential signal. In operation 530, the LVDS receiver included in the thermal printhead controller 180, receives the low voltage differential signal output from the main controller 130. The operation of the LVDS receiver included in the thermal printhead controller 180 will be described in greater detail below with reference to FIG. 2. Preferably, but not necessarily, the thermal printhead controller 180 also includes an LVDS driver (described in greater detail below with reference to FIGS. 2 and 3), which transmits a low voltage differential signal to the main controller 130.

In operation 540, the thermal printhead controller 180 converts the received low voltage differential signal into a second signal, which is a logic level signal. The second signal may be comprised of a transistor-transistor logic level (TTL) signal having a voltage of 5 V for example, or may be comprised of a complementary metal oxide semiconductor (CMOS) level signal having a voltage of 3.3 V for example.

In operation 550, the thermal printhead controller 180 generates control signals required for controlling the operation of the thermal printhead 120 based on the second signal and outputs the generated control signals. In operation 560, the thermal printhead 120 applies heat to a medium in response to the control signals output from the thermal printhead controller 180, thereby forming an image.

The thermal printhead controller 180 has been described in detail as one of a plurality of sub-controllers included in the image forming apparatus of FIG. 1. The LCD controller 160, which is also comprised of a sub-controller, may comprise an LVDS receiver (described in greater detail below with reference to FIGS. 2 and 3) which receives a low voltage differential signal output from the main controller 130 and generates and then outputs control signals required for controlling the operation of a display of the image forming apparatus. In addition, the Mecha controller 170, which is also comprised of a sub-controller, may comprise an LVDS receiver (described in greater detail below with reference to FIGS. 2 and 3) which receives a low voltage differential signal output from the main controller 130 and generates and then outputs control signals required for controlling the operation of a mechanical element of the image forming apparatus, such as a motor used for transferring the medium.

FIG. 2 is a circuit diagram illustrating an LVDS driver and an LVDS receiver that can receive and/or transmit a low voltage differential signal to and/or from each other according to an embodiment of the present invention. Referring to FIG. 2, the LVDS driver comprises a current source 200, which generates a current of 3.5 mA and converts an input signal D1 into a low voltage differential signal. The low voltage differential signal is transmitted via a transmission medium 220, such as a cable or a pattern.

The LVDS receiver comprises an OP amplifier 210, and receives the low voltage differential signal transmitted from the LVDS driver via the transmission medium 220. If the input signal D1 has a logic level of ‘1’, a current of 3.50 mA flows into a 100 Ω resistor included in the LVDS driver in a direction from nodes ‘a’ to ‘b’, and a voltage of 350 mV is applied across the 1000 resistor. Accordingly, the OP amplifier 210 has a voltage of 350 mV applied to the input terminals and outputs a logic level of ‘1’. If the input signal D1 has a logic level of ‘0’, a current flows into the 1000 resistor in a direction from nodes ‘b’ to ‘a’. Accordingly, the OP amplifier 210 outputs a logic level of ‘0’.

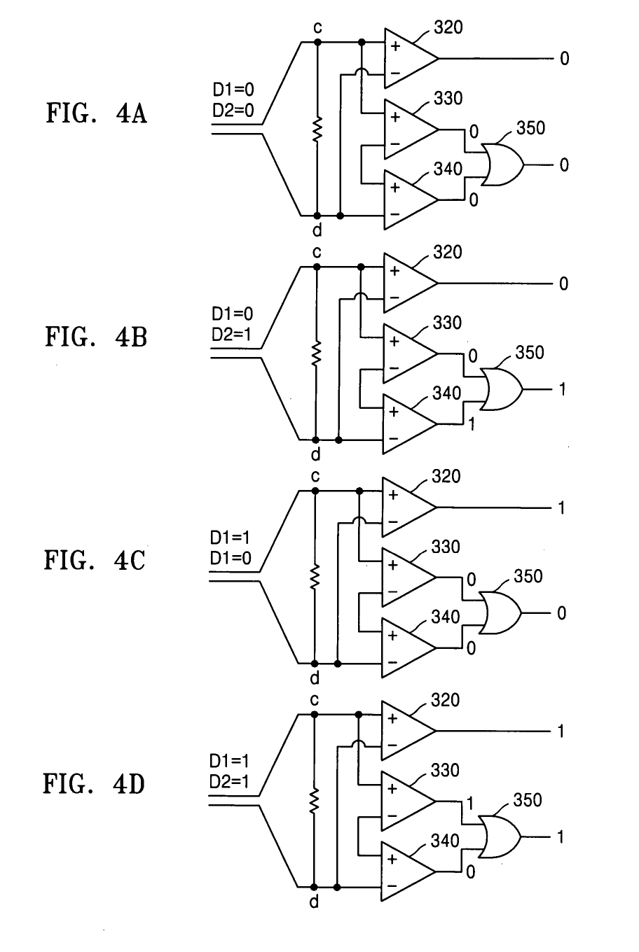

FIG. 3 is a circuit diagram illustrating another example of an LVDS driver and LVDS receiver that receive and/or transmit a low voltage differential signal to and/or from each other according to an embodiment of the present invention. Referring to FIG. 3, the LVDS driver comprises two current sources 300 and 310, and receives two input signals D1 and D2. The LVDS receiver comprises three comparators 320, 330, and 340, and an OR gate 350. Each of the comparators 320, 330, and 340 is preferably, but not necessarily, comprised of an OP amplifier. The operations of the LVDS driver and LVDS receiver of FIG. 3 will be described in greater detail below with reference to FIGS. 4A through 4D.

FIG. 4A illustrates the operations of the LVDS driver and LVDS receiver of FIG. 3 in a case wherein all of the input signals D1 and D2 have a logic level ‘0’. Referring to FIG. 4A, a current of 3.50 mA flows into a 1000 resistor included in the LVDS receiver in a direction from nodes ‘d’ to ‘c’, and a voltage of 350 mV is applied across the 1000 resistor. Accordingly, a signal OUT1 output from the first OP amplifier 320 and a signal OUT2 output from the OR gate 350 have a logic level of ‘0’.

FIG. 4B illustrates the operations of the LVDS driver and LVDS receiver of FIG. 3 in a case wherein the input signal D1 has a logic level of ‘0’ and the input signal D2 has a logic level ‘1’. Referring to FIG. 4B, a current of 7.00 mA flows into the 1000 resistor included in the LVDS receiver in the direction from nodes ‘d’ to ‘c’, and a voltage of 700 mV is applied across the 1000 resistor. Accordingly, the signal OUT1 has a logic level of ‘0’, a signal output from the second OP amplifier 330 has a logic level of ‘0’, and a signal output from the third OP amplifier 340 has a logic level of ‘1’. Accordingly, the signal OUT2 output from the OR gate 350 has a logic level of ‘1’.

FIG. 4C illustrates the operations of the LVDS driver and the LVDS receiver of FIG. 3 in a case wherein the input signal D1 has a logic level of ‘1’ and the input signal D2 has a logic level ‘0’. Referring to FIG. 4C, a current of 3.50 mA flows into the 100 Ω resistor included in the LVDS receiver in the direction from nodes ‘c’ to ‘d’, and a voltage of 350 mV is applied across the 100 Ω resistor. Accordingly, the signal OUT1 has a logic level of ‘1’, and the signals output from the second and third OP amplifiers 330 and 340 have a logic level of ‘0’. Accordingly, the signal OUT2 output from the OR gate 350 has a logic level of ‘0’.

FIG. 4D illustrates the operations of the LVDS driver and the LVDS receiver of FIG. 3 in a case wherein all of the input signals D1 and D2 have a logic level of ‘1’. Referring to FIG. 4D, a current of 7.00 mA flows into the 1000 resistor included in the LVDS receiver in the direction from nodes ‘c’ to ‘d’, and a voltage of 700 mV is applied across the 1000 resistor. Accordingly, the signal OUT1 has a logic level of ‘1’, the signal output from the second OP amplifier 330 has a logic level of ‘1’, and the signal output from the third OP amplifier 340 has a logic level of ‘0’. Accordingly, the signal OUT2 output from the OR gate 350 has a logic level of ‘1’.

Accordingly, it is possible to simultaneously transmit a 2-bit signal in one cycle of a clock signal using the LVDS driver and the LVDS receiver of FIG. 3.

According to embodiments of the present invention, it is possible to reduce the number of data lines required between a main controller and a sub-controller by transmitting data between the main controller and the sub-controller as low voltage differential signals. Thus, it is possible to enhance the performance of the image forming apparatus while reducing the manufacturing costs of the image forming apparatus according to embodiments of the present invention. In addition, it is also possible to reduce electromagnetic interferences (EMI) caused when transmitting data between the main controller and the sub-controller.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An image forming apparatus for use with a thermal printhead that prints an image by heating a medium, the image forming apparatus comprising:
a data input unit for receiving image data to be printed;
a control unit for generating a control signal used for driving a thermal printhead based on the received image data; and
a thermal printhead for printing an image by heating the medium in response to the control signal, wherein the control unit comprises:
a main controller comprising a low voltage differential signaling (LVDS) driver that converts a signal input thereto into a low voltage differential signal and outputs the low voltage differential signal; and
a sub-controller comprising an LVDS receiver that receives the low voltage differential signal from the LVDS driver of the main controller.

2. The image forming apparatus of claim 1, wherein the sub-controller is comprised of:
a thermal printhead controller for receiving a signal from the main controller, generating signals used for driving the thermal printhead based on the received signal, and outputting the generated signals.

3. The image forming apparatus of claim 1, wherein the sub-controller further comprises:
a converter for converting the low voltage differential signal received by the LVDS receiver into a transistor-transistor logic level (TTL) signal.

4. The image forming apparatus of claim 1, wherein the sub-controller further comprises:
a converter for converting the low voltage differential signal received by the LVDS receiver into a complementary metal oxide semiconductor (CMOS) level signal.

5. The image forming apparatus of claim 1, wherein the sub-controller further comprises:
an LVDS driver for receiving a signal from the main controller, converting the received signal into a low voltage differential signal, and outputting the low voltage differential signal.

6. The image forming apparatus of claim 1, wherein the main controller further comprises:
an LVDS receiver for receiving a low voltage differential signal output from the sub-controller.

7. The image forming apparatus of claim 1, wherein the LVDS driver comprises at least two current sources and at least two data input ports.

8. The image forming apparatus of claim 1, wherein the LVDS receiver comprises at least three comparators and at least an OR gate.

9. An image forming method using a thermal printhead that prints an image by heating a medium, the image forming method comprising the steps of:
receiving image data to be printed;
generating a first signal based on the received image data;
converting the first signal into a low voltage differential signal and outputting the low voltage differential signal;
receiving the low voltage differential signal and converting the low voltage differential signal into a second signal;
generating control signals used for controlling the operation of the thermal printhead based on the second signal; and
printing an image by heating a medium with the thermal printhead in response to the control signals.

10. The image forming method of claim 9, wherein the second signal is comprised of a TTL level signal.

11. The image forming method of claim 9, wherein the second signal is comprised of a CMOS level signal.
